(19) United States
(12) Patent Application Publication
(10) Pub. No.: US 2007/0133779 A1
(43) Pub. Date: Jun. 14, 2007

(54) Systems and method for call center processing

(76) Inventors: Sunil Kumar, Chandigarh (IN); Avtar Singh, Chandigarh (IN)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(21) Appl. No.: 10/560,724

(22) PCT Filed: Sep. 13, 2005
(86) PCT No.: PCT/US05/33159

§ 371 Date: Dec. 13, 2005

(51) Int. Cl. H04M 3/00; H04M 5/00

(52) U.S. Cl. 379/265.01

(57) ABSTRACT

Various systems and methods for call center processing are provided. As just one example, a method for call center processing is described that includes providing a call center system. The call center system includes a business object function implemented in a script language, and a communication layer. The method further includes receiving a data set, and applying the business object function to the data set. This application of the business object function to the data set creates a business object. The communication layer is applied to the business object which results in a conversion of the business object to an XML string that may be transmitted to a server.

### BACKGROUND OF THE INVENTION

The present invention relates to systems and methods for updating information across a computer network, and in particular to systems and methods for updating information in relation to a call center function.

In a typical call center application, a variety of rich buisness functionality is offered through use of a remote Internet server, and a terminal is used to access the functionality. The terminal is installed on a client machine that communicates with a central control. A flow diagram 100 shown in FIG. 1 and a system 200 shown in FIG. 2 shows a general approach for operating the terminal. System 200 includes a web server 215 connected to a database 220 loaded with business object functions. In addition, system 200 includes a terminal 205 with a display 208 and an input device 206. Terminal 205 is connected to web server 215 via a communication network 210. Following flow diagram 100, a website access is received at web server 215 from terminal 205 (block 105). In turn, web server 215 renders an HTML page in accordance with the request, and serves the rendered HTML page to terminal 205 via communication network 210 (block 110). It is then determined if additional requests are received from terminal 205 (block 115). Where an additional request is received (block 215), web server renders a page concuring with the additional request, and transmits the rendered page to terminal 205 (block 120).

Such an approach has at least two limitations. First, the types and amounts of data transfer do not scale well in an Internet environment. Second, such an approach often results in substantial flicker perceived by an operator monitoring display 208. As such, implementing such systems in an Internet environment often appear to have a non-linear increase in response time as the number of call center operators executing concurrent accesses to the system increases linearly.

Hence, for at least the aforementioned reasons, there exists a need in the art for advanced systems and methods to address the needs of the industry.

### BRIEF SUMMARY OF THE INVENTION

The present invention relates to systems and methods for updating information across a computer network, and in particular to systems and methods for updating information in relation to a call center function.

One or more embodiments of the present invention provide a highly scalable Internet based call center application that performs business logic on a client browser and in relation to a common Internet browser. Such systems may be designed such that page refreshes do not result in substantial flicker perceived by an operator of the client browser. In various instances of the embodiments, flicker is limited through use of an incremental renderer. This may eliminate page refreshes occurring upon each user action. The systems and methods in accordance with the foregoing embodiments may thus be able to deliver rich business functionality over the Internet, while scaling in an approximately linear fashion, and without undue screen flicker perceived by an operator.

Some particular embodiments of the present invention provide an Internet based application that performs business logic processing on a client machine. The client machine is communicably coupled to a server. Using this approach, response time perceived by an operator is largely a function of time spent on the client machine, and not controlled by time spent on a server and/or transmitting information to and from a server. Various embodiments of the present invention rely on rich business object functions executable within an Internet browser, and implemented using known scripting languages. Such scripting languages may facilitate transfer of the business object functions across the network, and integration with off the shelf Internet browsers.

Other embodiments of the present invention provide methods for call center processing. These methods include providing a call center system. The call center system includes a business object function implemented in a script language, and a communication layer. The method further includes receiving a data set, and applying the business object function to the data set. This application of the business object function to the data set creates a business object. The communication layer is applied to the business object which results in a conversion of the business object to an XML string that may be transmitted to a server. As just some examples, the business object function may be an order entry, a cutomer, an item, an order fulfillment, or an order status. Similarly, as just some examples, the remote function may be an order status update, an order fulfilment, a premium fulfilment, or a marketing access.

In some instances of the embodiments, the methods further include receiving another XML string that represents the first business object after application of a remote function, and converting the other XML string to a second business object. In some cases, the distributed access system further includes a renderer. In such cases, the method may further include providing the second business object to the renderer, and rendering and displaying the second business object. In particular cases, the renderer is an incremental renderer. In one or more cases, the methods may further include requesting the business object function, and receiving the business object function via the Internet.

Other embodiments of the present invention provide systems for call center processing in a distributed environment. Such systems include a distributed access system with a renderer, a business object function, and a communication layer. The business object function is implemented in a script language and is operable to form a business object based on an information input. The communication layer is operable to form the business object into an XML string. In some cases, the embodiments are implemented in software, while on other cases, the systems are implemented in some combination of software and hardware.

In one particular case, the communication layer is also operable to distribute the XML string to a remote server that performs a remote function on the XML string. The communication layer is further operable to distribute and receive a second XML string that represents the previously mentioned XML string after application of the remote function. The second XML string may then be converted to a second business object. The second business object may be rendered for display.

Yet other embodiments of the present invention provide methods for call center processing that include providing a call center application that is executable within a Internet browser environment. The methods further include receiving an access request that indicates a class of activities via the Internet browser environment. Based at least in part on the request, a business object function is distributed to a client machine. The business object function performs a function within the class of activities, and is accessible via the call center application and executable within the Internet browser environment. In some cases of the embodiments, the methods may further include receiving a business object XML string that is an XML string representation of a business object generated by the business object function. In some cases, the class of activities is an order entry class of activities. This order entry class of activities may include one or more business object functions such as, for example, a product information display, a product comparison display, a tax calculation, a shipping calculation, a delivery specification, a customer detail function, and a custom product specification. The business object function may be implemented in a script language such as, for example Jscript language.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIGS. 1 and 2 depict existing systems and methods for processing in an Internet environment;

FIG. 3 depict a system for call center processing in an Internet environment in accordance with various embodiments of the present invention; and

FIG. 4 depict a method for call center processing in an Internet environment in accordance with various embodiments of the present invention.

FIGS. 5 and 6 show exemplary pages that may be rendered and/or populated locally in accordance with one or more embodiments of the present invention.

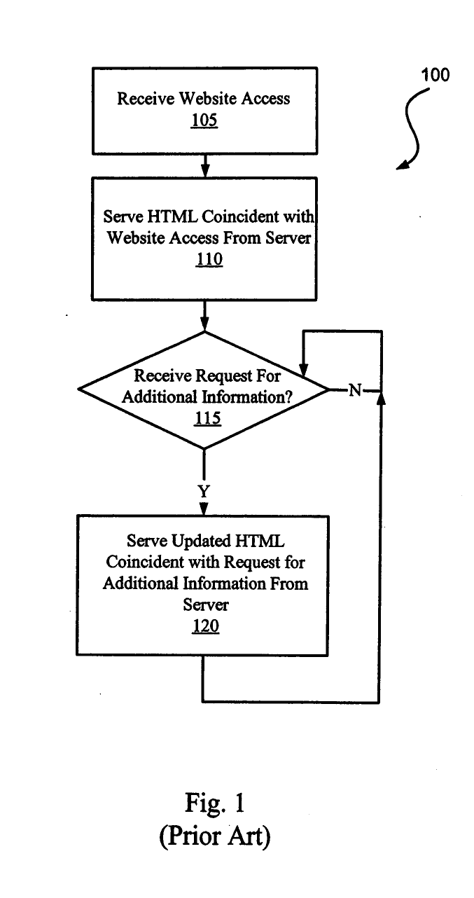

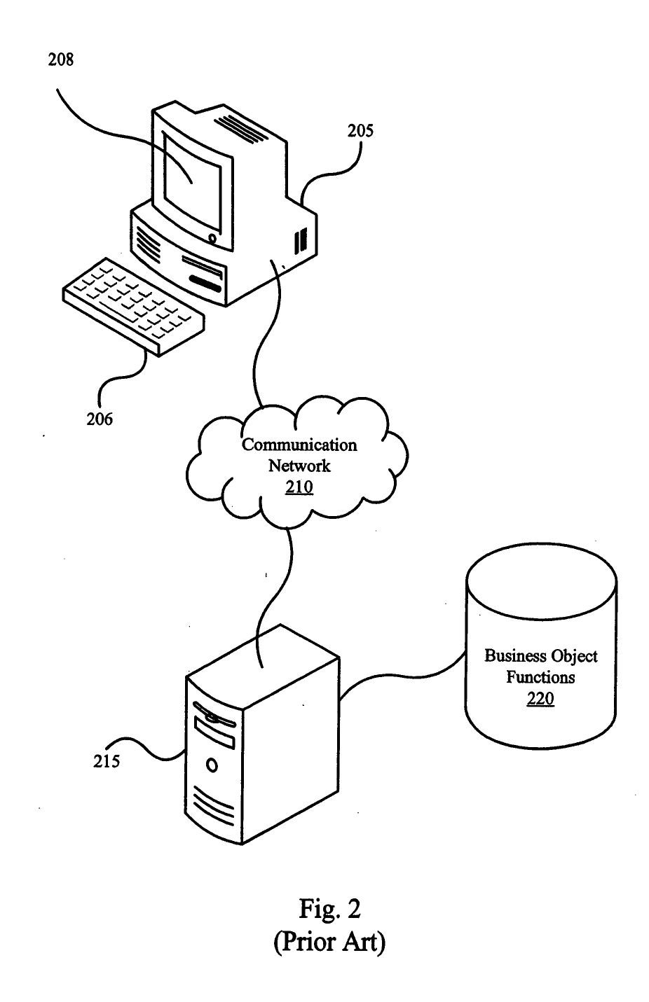

### DETAILED DESCRIPTION OF THE INVENTION

The present invention relates to systems and methods for updating information across a computer network, and in particular to systems and methods for updating information in relation to a call center function.

Some particular embodiments of the present invention provide a Internet based application that performs business logic processing on a client machine. The application may be, but is not limited to, a software application and/or an application implemented in both hardware and software. The client machine is communicably coupled to a server. As used herein, the term “communicably coupled” is used in its broadest sense to mean any type of coupling whereby information may be passed from one device to another. Thus, for example, two devices are communicably coupled when a wire is installed between the devices allowing for electrical signals to pass between there between. As another example, two devices are communicably coupled via an radio frequency when the devices are capable of receiving radio frequency communication. Further, two devices may be communicably coupled by an intervening device. It should also be noted that two devices may be communicably coupled through use of two or more couplings acting in combination. Thus, for example, two devices may be communicably coupled by both wireline and radio frequency controlled by an intervening device. Based on the disclosure provided herein, one of ordinary skill in the art will recognize a variety of communicable couplings that may be used in relation to one or more embodiments of the present invention.

Using the aforementioned approach, response time perceived by an operator is largely a function of time spent on the client machine, and not controlled by time spent on a server and/or transmitting information to and from a server. Various embodiments of the present invention rely on rich business object functions executable within a Internet browser, and implemented using known scripting languages. As used herein, the term “business object” denotes an information structure formed through application of a business object function. Thus, a business object may be, but is not limited to, a grouping of customer information, a grouping of item information, and/or the like. As used herein, the term “business object function” is any executable function that operates on business objects to produce an output and/or operates on an input to create a business object. Thus, a business object function may be, but is not limited to, a script language executable that formats a group of input information into an entered order, a script language executable that outputs an order cost, and/or the like. Based on the disclosure provided herein, one of ordinary skill in the art will recognize a variety of business objects and/or business object functions that may be used in relation to one or more embodiments of the present invention. Further, as used herein, the terms “scripting language” or “script language” are used in their broadest sense to mean any executable code known in the art that is known as and/or referred to as in any instance as a scripting language. As just one of many examples, a scripting language may be Jscript language. Such scripting languages may facilitate transfer of the business object functions across the network, and integration with off the shelf Internet browsers. Based on the disclosure provided herein, one of ordinary skill in the art will recognize a variety of script languages that may be utilized in relation to one or more embodiments of the present invention.

The aforementioned embodiments may rely on, among other things, one or more business object functions, a remote communication layer, and a hypertext markup language (hereinafter “HTML”) renderer. In general, the business object functions are implemented in a business object layer that provides a set of business object functions. One or more sets of business object functions may be combined in a class of activities. Examples of such business object functions may include, but are not limited to, an order function, a customer function, and an item function that provide public interface encapsulating complex business logic. The aforementioned exemplary business object functions may be grouped into, for example, an order capture class of activities. Such business object functions may be developed in Jscript language, and may be convertible into extensible markup language (hereinafter “XML”) string representations for transmission over the Internet. Further, these business object functions may be operable to form business objects based on input data. Based on the disclosure provided herein, one of ordinary skill in the art will recognize a variety of business objects and/or business object functions that may be used in relation to embodiments of the present invention.

The remote communcation layer converts the business objects into XML string representations, and communicates the XML stringe representations to an Internet server from a client machine. In some cases, this layer requests execution of a specific routine or function on the XML string to be performed by the Internet server, and upon execution of the routine or function receives an XML string in response. The received XML string may then be converted into an updated business object and/or business object function. The updated business object or business object function may be executable in a browser environement implemented on the client machine, and/or displayable using a display associated with the client machine. Based on the disclosure provided herein, one of ordinary skill in the art will recognize a variety of communication devices, software, and/or procedures that may be used in relation to embodiments of the present invention to implement one or more of the functional capabilities of the remote communation layer.

The HTML Renderer may be implemented in a rendering layer. The HTML renderer may receive business objects and generate an HTML view of the received business object on the client machine. In this way, the amount of rendering performed on an Internet server that must be transferred to the client machine for display may be reduced or eliminated. The HTML renderer may avoid flicker associated with page refreshes accomplished across the Internet. Further, in some cases, the HTML renderer may perform an incremental rendering that may further reduce any flicker perceived by the user. As just one of many examples of incremental rendering, when an operator selects an item for inclusion, the HTML renderer may generate HTML code only for a row associated with the new item instead of generating and refreshing the entire HTML view. Again, such an approach, amopng other things, may reduce the amount of flicker perceived by an operator upon refresh.

Various embodiments of the present invention provide methods for call center processing. These methods include providing a call center system. The call center system includes a business object function implemented in a script language, and a communication layer. The method further includes receiving a data set (e.g., some input information), and applying the business object function to the data set. This application of the business object function to the data set creates a business object. The communication layer is applied to the business object which results in a conversion of the business object to an XML string that may be transmitted to a server. As just some examples, the business object function may be an order entry, a cutomer, an item, an order fulfillment, or an order status. Similarly, as just some examples, the remote function may be an order status update, an order fulfilment, a premium fulfilment, or a marketing access.

Other embodiments of the present invention provide systems for call center processing in a distributed environment. Such systems include a distributed access system with a renderer, a business object function, and a communication layer. The business object function is implemented in a script language and is operable to form a business object based on an information input. The communication layer is operable to form the business object into an XML string. In some cases, the embodiments are implemented in software, while on other cases, the systems are implemented in some combination of software and hardware.

Yet other embodiments of the present invention provide methods for call center processing that include providing a call center application that is executable within an Internet browser environment. The methods further include receiving an access request that indicates a class of activities, and the request is received via the Internet browser environment. Based at least in part on the request, a business object function is distributed to a client machine. The business object function performs a function within the class of activities, and is accessible via the call center application and executable within the Internet browser environment. In some cases of the embodiments, the methods may further include receiving a business object XML string that is an XML string representation of a business object generated by the business object function. In some cases, the class of activities is an order entry class of activities. This order entry class of activities may include one or more business object functions such as, for example, a product information display, a product comparison display, a tax calculation, a shipping calculation, a delivery specification, a customer detail function, and a custom product specification. The business object function may be implemented in a script language such as, for example Jscript language.

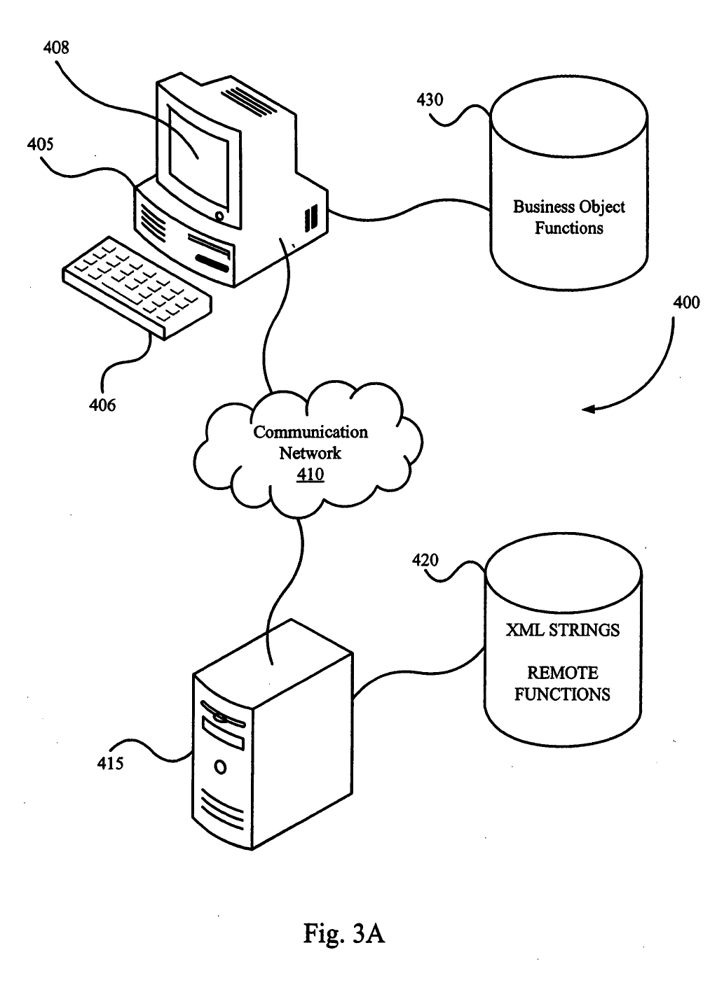

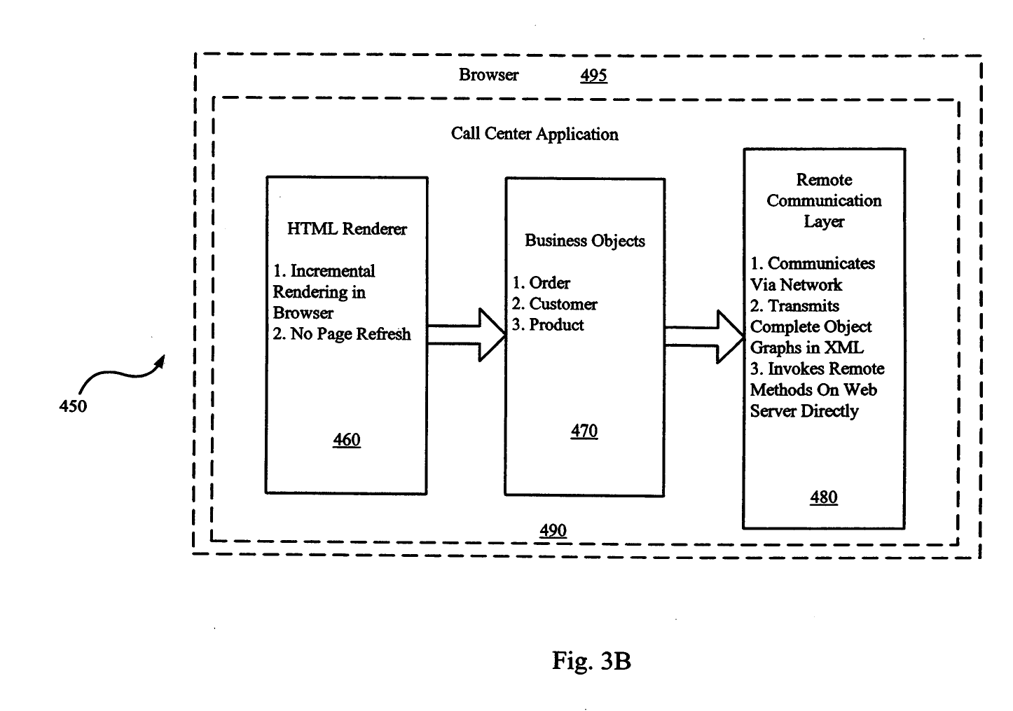

Turning to FIG. 3, a system 400 for distributed call center processing is depicted. System 400 includes a client machine 405 with a display 408 and an input device 406. Client machine 405 is associated with a computer readable medium 430. Computer readable medium 430 may be loaded to include, among other things, business object functions. In addition, client machine 405 is communicably coupled to an Internet server 415 via a communication network 410. As used herein, the term “computer readable medium” is used in its broadest sense to mean any media accessible via a computer. Thus, as just some of many examples, a computer readable medium may be a hard disk drive, a magnetic tape drive, an optical disk drive, a CD ROM, a random access memory, a floppy diskette, and/or the like. Internet server 415 is associated with a computer readable medium 420 that may be loaded with, among other things, various XML strings and various remote functions.

Communication network 410 may be any nework capable of communicably coupling client machine 405 and Internet server 415. Thus, as just some of many examples, communication network 410 is a local area network, a direct wire connection, a wireless network, a wide area network, an optical nework, and/or the like. In one particular case, communication network 410 is the Internet. Based on the disclosure provided herein, one of ordinary skill in the art will recognize a variety of networks, network combinations, and/or network equipment that may be used in relation to one or more embodiments of the present invention.

Client machine 405 is typically a microprocessor based machine capable of receiving input, providing information for display, and/or for exectuing various software programs including business object functions implemented in scripting languages. As just one example, client machine 405 may be a personal computer. Display 408 may be any device capable of portraying information to a user. Thus, for example, display 408 may be a monitor, a printer, and/or the like. Input device 406 may be any device capable of receiving information. Thus, for example, input device 406 may be a keyboard, a microphone, and/or the like.

Turning to FIG. 3B, a browser environment 450 in accordance with one or more embodiments of the present invention is depicted. As illustrated, browser environment 450 includes a browser 495, and a call center application 490 that is executable in relation to browser 495. Call center application 490 includes an HTML renderer 460, a group of business objects/business object functions 470, and a remote communication layer 480. In the particular embodiment, HTML renderer 460 is capable of incremental rendering that does not require complete page refresh. The business objects and/or business object functions may be selected from any class of activities including, for example, an order entry class that includes order, customer, and products business objects and business object functions. Remote communication layer 480 is capable of facilitating communication via a communication network.

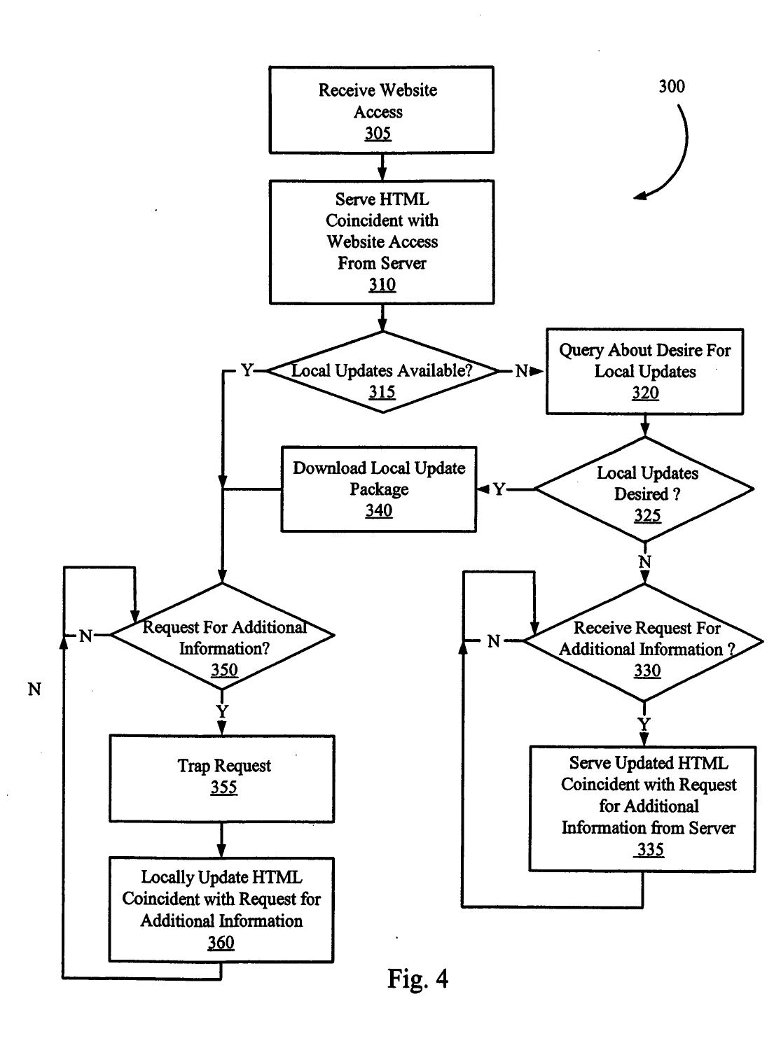

Turning to FIG. 4, a flow diagram 300 depicts a method in accordance with one or more embodiments of the present invention for call center processing. Following flow diagram 300, a request for an Internet site access is received (block 305). This may include, for example, receiving an Internet request issued by browser environment 495 using a URL to indicate a particular Internet site supported by Internet server 415. Upon receiving the Internet site access request (block 305), Internet server 415 renders information associated with the requested URL as an HTML page (block 310). This HTML page may be, for example, a home page of a service that is being accessed by an operator of client machine 405. In one particular example, this may be a home page of a company for which an order is being taken. In such a case, the company may employ a number of remotely located operators that take order requests for the company. In such a situation, the operators may access the company's home page for one of a variety of reasons including, but not limited to, authorization and software downloads. Based on the disclosure provided herein, one of ordinary skill in the art will appreciate a great variety of reasons for which an initial access via standard Internet approaches may be used in accordance with one or more embodiments of the present invention.

In addition to serving the initial access with an HTML page (block 310), it is determined if local updates are available (block 315). As used herein, the term “local updates” is used in its broadest sense to mean any functionality that may be accomplished on client machine 405 rather than remotely. Thus, for example, local updates may be accomplished through use of a number of business object functions that are installed on client machine 405. In such a case, the initial Internet access from client machine 405 to Internet server 405 may indicate a class of activities that may be accomplished locally on client machine 405. Further, it may include an enumeration of business object functions that may be accomplished locally on client machine 405. Further, it may indicate which of the enumerated business object functions are currently installed on client machine 405, and/or a revision date for the installed business object functions.

Where it is determined that something less than all functionality needed to perform the local updates is. available on client machine 405 (block 315), an operator accessing client machine 405 may be queried about whether the missing local updates are. desired (block 320). Where local updates are not desired (block 325), processing will be accomplished remotely on Internet server 415. Such processing may include, for example, awaiting a request from client machine 405 for additional information (block 330).

In an order entry scenario, this may include awaiting information provided by an operator related to a desired product. Upon receiving the request for additional information (block 330), Internet server 415 accesses the requested information and renders the information as an HTML page that is provided to client machine 405 (block 335). Thus, for example, in an exemplary order entry scenario, an operator of client machine 405 may receive various information related to a customer's order. This customer order information may include customer contact information, and desired product information. As this information is transmitted by client machine 405 to Internet server 415, Internet server 415 renders corresponding HTML pages that are served to client machine 405. These newly rendered HTML pages are refreshed to display 408 and the operator of client machine 405 continues with a semi-real time information update via display 408. However, proceeding this way may result in substantial delay and/or screen flicker as previously discussed.

Alternatively, where it is determined that local updates are desired (block 325), the needed local updates are formatted and downloaded to client machine 405 by Internet server 415 (block 340). In some embodiments, this may include transmitting one or more business object functions from Internet server 415 to client machine 405. In various cases, the business object functions are implemented in a script language such as, for example, Jscript language. Transmission of the business object functions is accomplished by converting the business object functions into XML strings, and transmitting the XML strings across the Internet from Internet server 415 to client machine 405. In turn, remote communication layer 480 of call center application 490 that is installed within browser environment 495 on client machine 405 receives the transmitted XML string. The received XML string is converted to the original business object function in script language that is installed with business objects/business object functions 470. A such, the received business object function may be executed to perform one or more tasks local to client machine 405. As just one of many examples, the following is a business object function written in Jscript language that accepts an XML string from the server, and constructs a display object:

/*xmlDOM:Reference to the DOM tree corresponding to the Address node
in the XML to be unmarshalled. This will be of type IXMLDOMNode.
parentRef: Reference to the parent, if any, of this object. Null,
otherwise.*/
function QAddress_initializeFromXMLDOM(xmlDOM, parentRef)
{

//Call common initializer
this.initializeValuesOnConstruction( );
//Initialize parent reference
this._parent = parentRef;
//Unmarshall the incoming XML
this.unmarshallFromXMLDOM(xmlDOM);

}

It will be recognized by one of ordinary skill in the art that a number of different implementations for a given business object function are possible in accordance with one or more embodiments of the present invention. Further, it should be noted that the aforementioned business object function is merely exemplary and calls other functions that may or may not be included in the particular business object function. Based on the disclosure provided herein, one of ordinary skill in the art will recognize a variety of business object functions and implementations thereof that may be utilized in accordance with the various embodiments of the present invention.

Where it is either determined that all functionality needed to perform the local updates is available on client machine 405 (block 315) or the needed information is updated to client machine 405 (block 340), processing that includes local updating is continued. Processing includes awaiting a request by the operator for additional information or entry by the operator of additional information (block 350). In an order entry scenario, this may include awaiting information provided by an operator related to a desired product. Upon receiving the request for additional information (block 350), client machine 415 (relying on call center application 490) may make a determination about whether handling of the additional information may be handled via the existing business object functions. Where this is possible, the request for additional information or the input of additional information is trapped (block 355).

Trapping the request for additional information stops the process of requesting the additional information from Internet server 415 as previously described in relation to block 335. Instead of issuing the request to Internet server 415, the request is handled by the appropriate business object function and results in the creation of a related business object local to client machine 405. In addition, HTML renderer 460 is accessed to generate information that may be updated to display 408 via browser environment 495 (block 360).

In some cases, a business object created by the aforementioned business object function is transmitted to Internet server 415 for additional processing by a remote function implemented as part of Internet server 415. Prior to transmitting the business object, remote communication layer 480 converts the business object to an XML string. The XML string is transmitted and receive by Internet server 415. Internet server 415 executes the appropriate remote function on the business object. The result may be formatted as an XML string and transmitted back to client machine 405. At client machine 405, remote communication layer 480 converts the received XML string into the appropriate result, and in some cases, a business object function is executed to operate on the received result. In some cases, the result is also provided to HTML renderer 460, and is updated to display 408 either incrementally or as an entire page.

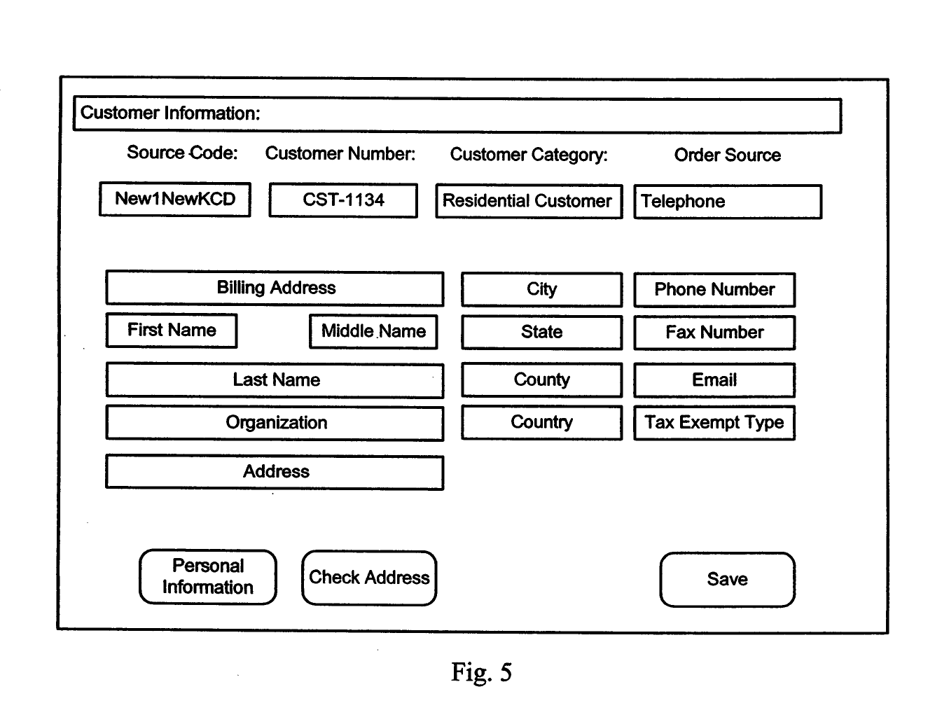

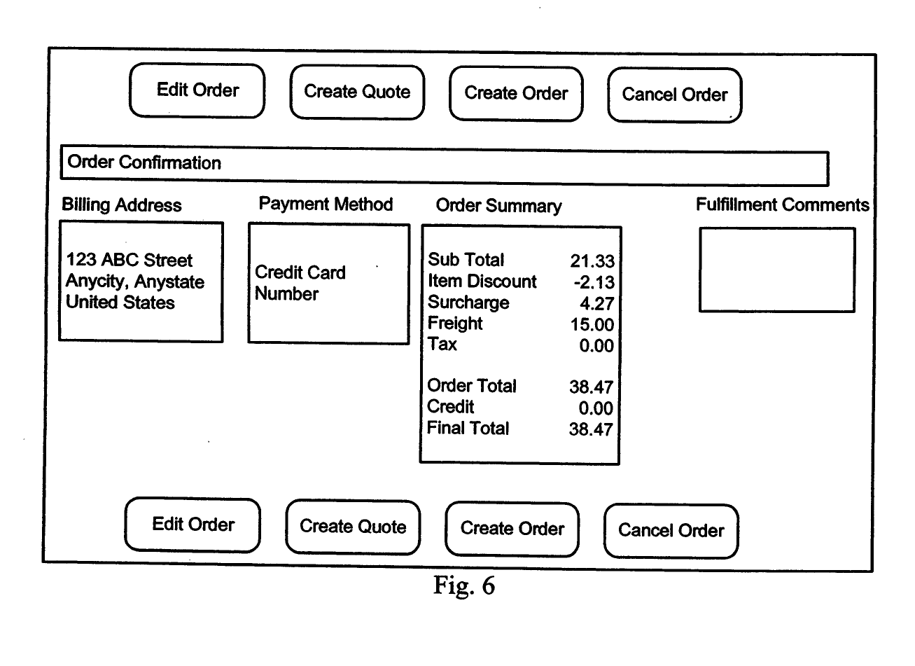

FIGS. 5 and 6 show exemplary pages that may be rendered and/or populated locally in accordance with one or more embodiments of the present invention. As just one example, information garnered via the page of FIG. 5 may be formed as an XML string that is output to a server. In contrast, the page of FIG. 6 may be rendered based on an XML string that is received from the server and rendered locally. Based on the disclosure provided herein, one of ordinary skill in the art will recognize a number of different pages and/or interfaces that may be used and/or manipulated in accordance with the various embodiments of the present invention.

In conclusion, the present invention provides novel systems, methods and arrangements for exchanging data. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for call center processing, the method comprising:
providing a call center system, wherein the call center system includes:
a business object function, wherein the business object function is implemented in a script language; and
a communication layer; receiving a data set;
applying the business object function to the data set, wherein the business object function creates a business object;
applying the communication layer to the business object, wherein the buisness object is converted to an XML string; and
transmitting the XML string to a server, wherein a remote function is applied to the XML string.

2. The method of claim 1, wherein the business object is a first business object, wherein the XML string is a first XML string, and wherein the method further comprises:
receiving the second XML string, wherein the second XML string represents the first business object after application of the remote function; and
converting the second XML string to a second business object.

3. The method of claim 2, wherein the distributed access system further includes a renderer, and wherein the method further comprises:
providing the second business object to the renderer; and
rendering and displaying the second business object.

4. The method of claim 3, wherein the renderer is an incremental renderer.

5. The method of claim 1, wherein the business object function is selected from a group consisting of: an order entry, a cutomer, an item, an order fulfillment, and an order status.

6. The method of claim 1, wherein the remote function is selected from a group consisting of: an order status update, an order fulfilment, a premium fulfilment, and a marketing access.

7. The method of claim 1, wherein the method further comprises:
requesting the business object function; and
receiving the business object function via the Internet.

8. A system for call center processing in a distributed environment, the method comprising:
a distributed access system, wherein the distributed access system includes:
a renderer;
a business object function, wherein the business object function is operable to form a business object based on an information input, and wherein the business object function is implemented in a script language; and
a communication layer, wherein the communication layer is operable to form the business object into an XML string.

9. The system of claim 8, wherein the XML string is a first XML string, and wherein the communication layer is further operable to:
distribute the first XML string to a remote server, wherein the remote server performs a remote function; and
receive a second XML string, wherein the second XML string represents the first XML string after application of the remote function.

10. The system of claim 9, wherein the business object is a first business object, and wherein the business object function is operable to:
receive the second XML string from the communication layer,
convert the second XML string to a second business object.

11. The system of claim 10, wherein the renderer is operable to render the second business object for display.

12. A method for call center processing, the method comprising:
providing a call center application, wherein the call center application is executable within a Internet browser environment;
receiving an access request, wherein the access request is received via the Internet browser environment, wherein the access request indicates a class of activities; and
based at least in part on the request, distributing a business object function, wherein the business object function performs a function within the class of activities, wherein the business object is accessible via the call center application, and wherein the business object function is executable within the Internet browser environment.

13. The method of claim 12, wherein the method further includes:
receiving a business object XML string, wherein the business object XML string is an XML string representation of a business object generated by the business object function.

14. The method of claim 13, wherein the business object XML string is a first business object XML string, and wherein the method further includes:
performing a remote function on the first business object XML string, wherein the function provides a business object output; and
transmitting the business object output as a second business object XML string to the Internet environment.

15. The method of claim 14, wherein the remote function is selected from a group consisting of: an order status update, an order fulfilment, a premium fulfilment, a marketing access.

16. The method of claim 12, wherein the class of activities includes an order entry class of activities.

17. The method of claim 16, wherein order entry class of activities includes a business object function selected from a group consisting of: a product information display, a product comparison display, a tax calculation, a shipping calculation, a delivery specification, a customer detail function, and a custom product specification.

18. The method of claim 12, wherein the business object function is implemented in a script language.

19. The method of claim 18, wherein the script language is a Jscript language.

20. The method of claim 18, wherein the method further includes:
converting the business object from script language to an XML string for transmission to the Internet browser environment.
